(19) United States
(12) Patent Application Publication
(10) Pub. No.: US 2018/0292973 A1
(43) Pub. Date: Oct. 11, 2018

(54) SINGLE LAYER USER INTERFACE

(71) Applicant: I/O INTERCONNECT, LTD., SANTA ANA, CA (US)

(72) Inventor: Gary KUNG, Santa Ana, CA (US)

(21) Appl. No.: 15/701,637

(22) Filed: Sep. 12, 2017

Related U.S. Application Data
(60) Provisional application No. 62/483,595, filed on Apr. 10, 2017.

(51) Int. Cl. G06F 3/0481; G06F 3/0484; G06F 3/14

(52) U.S. Cl. CPC G06F 3/04817; G06F 3/1454; G06F 3/04847

(57) ABSTRACT

Present disclosure relates to a single layer user interface and a method for providing thereof. The single layer user interface is provided to control a docking interface when peripheral devices are coupled to the docking interface. A selection with only two options is provided on the single layer user interface regardless how many possible manipulations that the docking interface or the peripheral devices can provide. The first option in the selection is a default and most favorable option. The single layer user interface may comprise an optimization module to store the selection record that has been made.

### CROSS-REFERENCE TO RELATED APPLICATION

This application claims priority to U.S. Provisional Application Ser. No. 62/483,595, filed on Apr. 10, 2017, which is herein incorporated by reference.

### BACKGROUND

### Field of Invention

Present disclosure relates to a user interface. More particularly, the present disclosure relates to a single layer user interface.

### Description of Related Art

Nowadays, controls to computers or peripheral devices are usually applied via a certain user interfaces. For example, when a user connects a keyboard (or a mouse) as an I/O (input/output) device to a computer, there will be some menus filled with plenty options provided on the computer, such as drop-down list, side menus, right-click menus, etc. Although mentioned menus are very popular for being provided in user interfaces, most of them are not user-friendly. These interfaces provided with menus usually contain multiple layers of options, and each layer comprises more sub options. In fact, many of these options are difficult for an ordinary user to understand or even hardly used. As current menu interfaces are so complicated and inconvenient, some improvements are necessary.

### SUMMARY

The disclosure provides a single layer user interface. The single layer user interface is utilized for controlling a docking interface, in which the docking interface comprises a control panel displayed on a computer. The single layer user interface comprises a selection, wherein the selection is provided on the control panel when at least one peripheral device is coupled to the docking interface. The selection is provided with only a first optional item and a second optional item. If the selection is unmade, as a default option, the first optional item would be automatically selected.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a single layer user interface according to some embodiments of the present disclosure;

FIG. 2 is a schematic diagram of a single layer user interface according to some embodiments of the present disclosure;

FIG. 3 is a schematic diagram of a single layer user interface according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

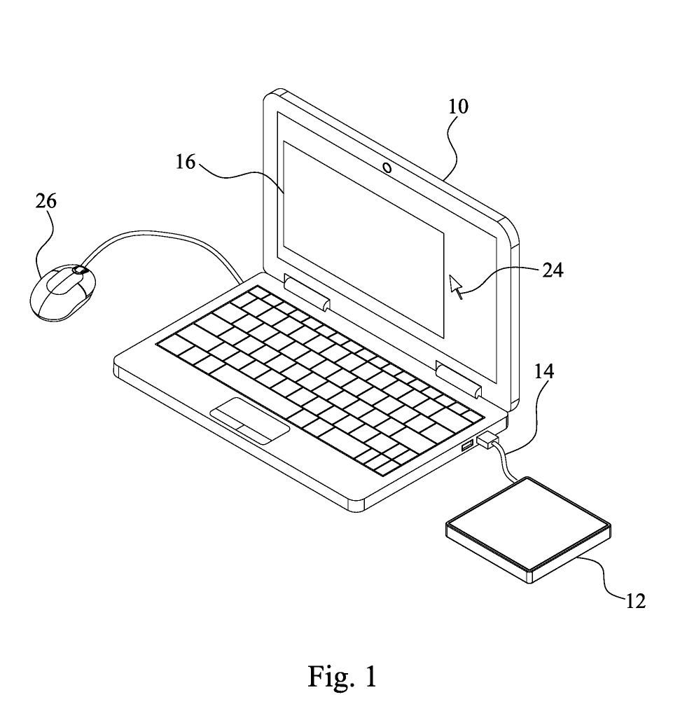

FIG. 1 is a schematic diagram of a single layer user interface according to some embodiment of the present disclosure. As illustrated in FIG. 1, in one embodiment, a docking interface 12 is electrically coupled to a laptop 10 via a cable 14 (for example, a USB 3.1 type C cable). Driving or control software corresponding to the docking interface 12 has been installed on the laptop 10. A single layer user interface is provided on the laptop 10 for controlling the docking interface 12. Accordingly, when the docking interface 12 is coupled to the laptop 10, a control panel 16 of the single layer user interface is provided on the display of the laptop 10.

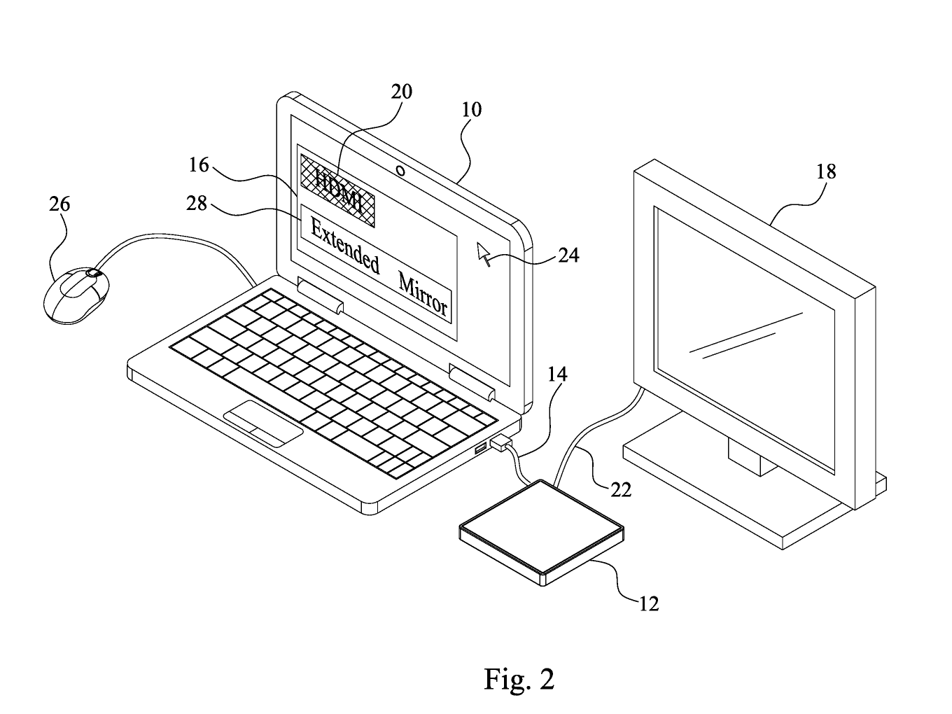

FIG. 2 is a schematic diagram of a single layer user interface according to some embodiment of the present disclosure. To the embodiment of FIG. 1, when a monitor 18 is electrically coupled to the laptop 10 through the docking interface 12, a notification may be displayed on the control panel 16, as shown in FIG. 2. In the embodiment, a HDMI icon 20 is displayed on the control panel 16 and being highlighted. In some embodiments, possible alternatives, such as providing text notifications or background color changing, may be provided to the control panel 16. In the embodiment of FIG. 2, the monitor 18 is connected to the docking interface 12 through a HDMI cable 22.

In aforementioned embodiment, a selection may be provided on the control panel 16 with the notification. The selection is provided with only two optional items 28 for the user to select a single one between them. The two optional items 28 are provided with regard to the available operations of the docking interface 12 or the available operations of at least one peripheral device being coupled to the docking interface. The two optional items 28 are determined according to possible manipulations that the docking interface may provide. As shown in FIG. 2, since monitor 18 is a display device, therefore a first optional item named “Extended” and a second optional item named “Mirror” may be provided on the control panel 16 when the monitor 18 is coupled to the docking interface 12. Each of the two optional items 28 in the selection represents a mode of the display that an ordinary user may access from the monitor 18. When the user selects the first optional item, the operation of the monitor 18 is switched to extended mode. When the user selects the second optional item, the operation of the monitor 18 is switched to mirror mode. To a person familiar with a display, four regular options are often provided in the connection between a monitor and a computer, which are: monitor only, computer only, extended mode and mirror mode. As a purpose of present disclosure is to provide a more user-friendly interface, only the most frequently used two options may be presented in the single layer interface.

In some embodiment, the single layer user interface further comprises an optimization module to store or manage these two optional items 28. A predetermined table with preset optional items is stored on the optimization module. Since the extended mode and the mirror mode are the most popular options employed on a display, the extended mode may be stored as the first optional item and the mirror mode may be stored as the second optional item on the predetermined table. In each time the at least one peripheral device is coupled to the docking interface 12, the single layer user interface provides a selection with the first optional item and the second optional item according to the predetermined table.

In some embodiment, the single layer user interface saves the result of the last selection made by the user. For example, if “Extended” was the optional item being selected in last selection, the next time the monitor 18 is coupled to the laptop 10 via the docking interface 12 the single layer user interface may provide “Extended” as the first optional item and “Mirror” as the second first optional item to the control panel 16. For another example, if “Mirror” was the optional item being selected in last selection, the next time the monitor 18 is coupled to the laptop 10 via the docking interface 12 the single layer user interface may provide “Mirror” as the first optional item and “Extended” as the second first optional item. In some embodiment, if the user ignores the selection and the selection is unmade, the first optional item would be automatically selected by the single layer interface as a default option. The automatic selection may be executed in a time period if the decision was not made by the user. The time period is a predetermined but modifiable time period.

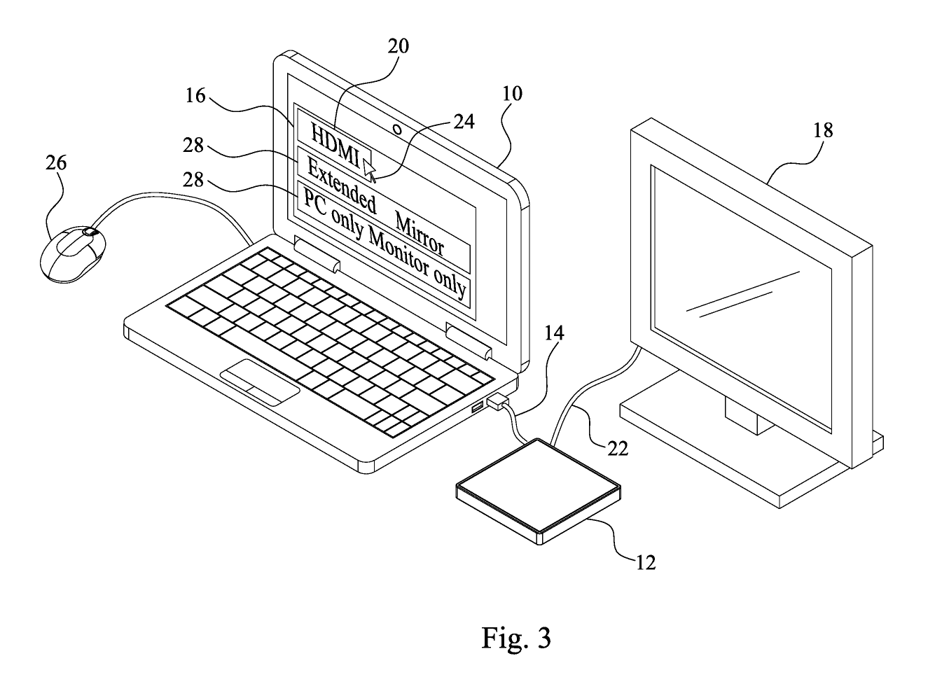

FIG. 3 is a schematic diagram of a single layer user interface according to some embodiment of the present disclosure. In some embodiment, the monitor 18 has connected to the laptop 10 for a while and the monitor 18 currently operates in mirror mode. When the user moves cursor 24 to the HDMI icon 20 of the control panel 16, a list contains optional items more than the first optional item and the second optional item may be presented on the control panel 16. When the user moves cursor 24 onto control panel 16, the list contains optional items more than the first optional item and the second optional item may be presented on the control panel 16 as well. Herein the cursor 24 refers to a visual indicator displayed on the laptop 10, which is provided for showing the moving trail of a mouse 26 being electrically coupled to the laptop 10. Different from the configuration in FIG. 2, there are two sets of the two optional items 28 being provided on the control panel 16. The first set of the two optional items 28 contains a first optional item named “Extended” and a second optional item named “Mirror”. The second set of the two optional items 28 contains a third optional item named “PC only” and a fourth optional item named “Monitor only”. The configuration provides the user with other available optional items in case of that the user would like to access some operations other than the first optional item and the second optional item. In foregoing embodiment, if the user does not select any optional item after the cursor 24 being moved to the control panel 16, the single layer user interface remains same settings. In some embodiment, a dynamic table is stored on the optimization module. The dynamic table is provided with a set of the first optional item and the second optional item, wherein the set of optional items is dynamically updated based on a selection record. The selection record is a collection of historical selections that has been made before. The optimization module stores the first optional item or the second optional item being selected by the user in a selection as an entity of the selection record. The optimization module also stores the first optional item being automatically selected in an unmade selection as an entity of the selection record.

The single layer user interface provides the first optional item and the second optional item according to the dynamic table. The optional items in the dynamic table are updated with the most frequently selected optional items in the selection record. As the most favorable option to the user, the first optional item may be updated with a most frequently selected optional item in the selection record, the most frequently selected optional item may be one of the first or the second optional item in regard with how often they were selected. If the second optional item outnumbered the first optional item in the selection record, the second optional item becomes the first optional item in the dynamic table, and vice versa. Accordingly, the second optional item may also be updated with a second frequently selected optional item in the selection record, may be one of the first or the second optional item in regard with how often they were selected. In general, the second frequently selected optional item would be the one other than the most frequently selected optional item in the selection record.

In aforementioned embodiments, although the single layer user interface is provided on the control panel for controlling the docking interface, the scope of present disclosure should not be limited to these exemplary embodiments. The single layer user interface of present disclosure may be applied to any option menu for other purposes. The main idea of present disclosure is: when an option menu regarding to a device or service has more than two regular options, provides a single layer user interface with only two favorable options to the user, and if the selection is unmade, the first option would be selected automatically. According to the idea, present disclosure provides a simple and user-friendly interface.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A single layer user interface for controlling a docking interface, wherein a control panel corresponding to the docking interface is displayed on a computer, wherein the single layer user interface comprises:
a selection, provided on the control panel when at least one peripheral device is coupled to the docking interface, wherein the selection is composed of only a first optional item and a second optional item, and the first optional item is automatically selected if the selection is unmade by a user.

2. The single layer user interface of claim 1, further including:
an optimization module having a predetermined table stored thereon, wherein the predetermined table is provided for storing the first optional item and the second optional item.

3. The single layer user interface of claim 1, further including:
an optimization module having a dynamic table stored thereon, wherein the dynamic table is provided for storing the first optional item and the second optional item, and wherein the first optional item and the second optional item stored on the dynamic table are dynamically updated based on a selection record.

4. The single layer user interface of claim 3, wherein the first optional item on the dynamic table is updated with a most frequently selected optional item from the selection record, and wherein the second optional item is updated with a second most frequently selected optional item from the selection record.

5. The single layer user interface of claim 3, wherein the optimization module stores the first optional item or the second optional item into the selection record when the selection is made by the user.

6. The single layer user interface of claim 3, wherein the optimization module stores the first optional item being automatically selected into the selection record when the selection is unmade by the user.

7. The single layer user interface of claim 1, wherein the first optional item and the second optional item are provided with regard to at least two available operations of the docking interface.

8. The single layer user interface of claim 1, wherein the first optional item and the second optional item are provided with regard to at least two available operations of the at least one peripheral device being coupled to the docking interface.

9. The single layer user interface of claim 1, wherein the first optional item is automatically selected if the selection is unmade in a predetermined time period.

10. The single layer user interface of claim 1, wherein the first optional item is a mirror mode and the second optional item is an extended mode.
